(19) United States
(12) Patent Application Publication
(10) Pub. No.: US 2010/0175899 A1
(43) Pub. Date: Jul. 15, 2010

(54) Extinguishing Device

(76) Inventor: Christof Burkart, Furtwangen (DE)

Correspondence Address: THE WEBB LAW FIRM, P.C., 700 KOPPERS BUILDING, 436 SEVENTH AVENUE, PITTSBURGH, PA, 15219, US

(21) Appl. No.: 12/377,208

(22) PCT Filed: Aug. 13, 2007
(86) PCT No.: PCT/DE07/01429

§ 371 Date: Feb. 11, 2009

(30) Foreign Application Priority Data
Aug. 12, 2006 (DE) 10 2006 037 824.5
Oct. 30, 2006 (DE) 10 2006 051 697.4

(51) Int. Cl. A62C 27/00; A62C 31/28

(52) U.S. Cl. 169/52; 169/70

(57) ABSTRACT

The invention relates to a device for extinguishing fires and/or distributing extinguishing agents, comprising at least one displaceable distinguishing arm through which the extinguishing agent is guided, and an extinguishing tip that is secured to an outer end of said arm, in addition to a transport or securing unit that is arranged on the another end of said device. Essentially, the extinguishing arm comprises, in the longitudinal direction, at least two articulated segments that are joined together. The number and length of said segments are arranged such that the extinguishing tip can be placed in the direct proximity of the source of the fire when used for fighting fires.

The invention relates to an extinguishing apparatus according to the features of the preamble of claim 1.

In particular, the invention relates to extinguishing apparatuses such as are required when fighting large fires and/or sources of fire that are difficult to access.

It is known in the art that the fire brigade can fight large fires from above with the aid of hydraulically extendable turntable ladders. A firefighter stands in this case above in a rescue basket and holds a jet pipe of a fire hose pointing in the direction of the source of the fire in order to spray water from above onto the flames. There are also embodiments in which spraying systems are fixedly installed on the rescue basket in order to reduce the recoil of the water for the firefighter. In this case, the water is sprayed or cast in thick jets onto the flames at a temperature such as occurs in a drinking water system or an extinguishing water supply such as for example a lake, stream, etc. The water is in this case passed over a long distance through heat and fumes up to the source of the fire and subsequently flows away.

Generally, a source of a fire is difficult or even impossible to see and access through fumes or owing to heat and flames. For this reason, the fire brigade can often only spray into the middle of the flames without being able to see a precise target. In this case, up to 98% of the water is wasted as it runs down the building or burning articles, or evaporates in the upper part of the flames before it can get close to the source of the fire where it is involved in the extinguishing process. As the water flows down, the water can become contaminated, leading to further environmental pollution.

In the case of a forest fire, a gas or oil fire, the walls of flames and temperatures are too high to allow a firefighter to get very close to the source of the fire. Therefore, large fires usually cannot be extinguished directly. They are simply prevented from spreading. Often, firefighters are exposed to very great risks when fighting fires in the event of an inside attack in order to get closer to a source of a fire where the extinguishing agent can be effectively used.

The technology of converting decommissioned military vehicles for extinguishing also harbours great dangers. DE 202 01 268 U1 refers to tracked vehicles which are not protected against heat. A vehicle of this type can itself carry only a small amount of water, and always requires operators in the danger area. As soon as the supply of extinguishing water and thus also the vehicle's own water for cooling the surface thereof have been used up, the vehicle must use its own power to move out of the danger area. If it is unable to do this, the steel shell of the vehicle offers no protection from the heat, placing the operators' lives at risk.

DE 698 25 315 T2 proposes an extinguishing device which allows only a short distance to the source of the fire and in addition requires a hose connection to a stationary and pressure-generating apparatus.

DE 3800037 describes a telescopically extending, extinguishing apparatus, although this has just a single flexible joint which must however, owing to the open design, be located outside the heat region of a fire. Extinguishing from the bottom up is neither provided nor possible. Also, a high water pressure in the pipe carrier makes the use of flexible joints impossible.

JP 11128383 A of 18.05.99 discloses a high-pressure tower ladder with a spray nozzle. Nevertheless, the external actuators prevent operation of the arm in the fire.

The object of the invention is therefore to provide a high-performance and effective extinguishing apparatus with which a fire can be effectively fought without the extinguishing personnel being in direct proximity to the source of the fire and without particularly high risks for the fire brigade personnel and with which a large portion of the extinguishing agents can be saved.

According to the invention, this object is achieved by means of an extinguishing device having the features according to claim 1. Advantageous developments of the invention emerge from the features specified in the sub-claims.

The object is achieved by one or more flexibly configured extinguishing channels or extinguishing arms. In this case, individual segments of the extinguishing arm are movably connected to one another via joints. The individual segments of the extinguishing arm can be moved or rotated relative to one another by means of one or more actuators and thus allow precise positioning of the extinguishing tip above the source of the fire. This includes for example translation, such as is conventional in telescopic arms, and also the bending movement via an intermediate joint relative to one another, and also the rotation of two or more segments about their longitudinal axis. The individual segments are connected to one another by means of a flexible seal. This gives rise to the main advantage of the device according to the invention, namely the fact that an extinguishing tip can be brought right up close to the source of the fire, where a fire is fought most effectively. In addition, the health and the life of the fire brigade personnel is protected as they now no longer have to expose themselves to incalculable and unnecessary dangers.

A further advantage of the invention consists in the fact that the design and configuration of the extinguishing arm can be adapted without greatly restrictive boundary conditions to the requirements of the individual fire brigades and fire brigade vehicles. In this case, different dimensions with regard to size and cross section are possible and also a number of segments of the extinguishing arm that is adapted to requirements can be implemented.

The extinguishing arm can be designed to convey water at a low pressure of approx. 5 bar. It is simply necessary to overcome the difference in height of the obstacle to be overcome. Thus, the hydraulic drives need operate merely against this low pressure and can accordingly be relatively small and light. This increases the maximum possible length, in terms of design, of the extinguishing arm or costs are reduced in the case of relatively small embodiments.

In addition, depending on the manufacturing material and cross section, the hollow profiles can accommodate a very high (water) pressure. Accordingly, the segments themselves or hoses and lines integrated therein can withstand pressures greater than 250 bar. A normal water-conveying fire hose would not be able to cope with such high pressures and could not be conveyed.

A particular advantage of the individual segments, which are embodied as hollow carriers, consists in the fact that the liquid passed therethrough cools the segment itself. For this reason, it is possible to make the individual segments also from materials which have to meet merely low requirements with regard to heat resistance and can thus be produced more economically.

It is furthermore expedient to pass additional lines through the hollow carrier instead of outside the segments if these lines are to be protected from heat. Thus, for example, it is conceivable to pass electric, hydraulic, pneumatic lines inside the segment and to cool said lines also by means of the liquid present in the hollow carrier. In anticipation of the description of an exemplary embodiment, reference is made to the need for further feed lines within the segment, if for example the extinguishing tip has sensors and cameras which have to be powered and the information from which has to be tapped.

In a particularly advantageous configuration of the invention, the extinguishing arm is provided at one end with a movable extinguishing tip. The extinguishing tip can be purposefully controlled and a fire thus be fought more effectively. As mentioned hereinbefore, the controlling can be carried out as a function of the information tapped via sensors and cameras. Owing to the use of an extinguishing tip of this type, extinguishing agents and further resources can again be saved or spared. Also, the fire brigade personnel are as a result not exposed to the direct heat and imminent dangers. Also, the targeted extinguishing use by means of the controllable extinguishing tip can greatly reduce the time for fighting the fire or the burning and thus greatly limit the possible damage. The damage includes both the damage caused by the fire itself and the accompanying damage.

The articulated design of the extinguishing arm allows optimum extinguishing also from “the bottom up”. A carpet of water vapour and/or water drops can be laid at the lowest point or the lowest plane of the source of the fire. This carpet cools the source of the fire to below its ignition temperature, and at the same time displaces the atmospheric oxygen which might sustain the fire.

Instead of a movable extinguishing tip, it is also possible to attach further movable tools to one end of the extinguishing arm. Thus, for example, it is conceivable to use a breaking, cutting or drilling tool to clear a path to the source of the fire. The tools can in this case also be combined with one another.

It has proven advantageous to additionally secure a drill head by means of a bolt-firing head in/on the obstacle, for example a wall, thus allowing the vibrations which occur to be kept as low as possible during use.

It is also conceivable to use a plurality of extinguishing arms at the same time to fight the source of the fire, wherein different tools can be used. These extinguishing arms can be used from the same position; for example the same (travelling) base or else from different locations, i.e. a plurality of different, for example, vehicles. In addition, a plurality of extinguishing arms can form a stabler carrying structure, wherein the individual extinguishing arms assist and support one another.

As a result of the fact that the extinguishing tip can be brought up close to the source of the fire, it is possible to profit from a further advantage resulting therefrom: the extinguishing tip can be configured as a continuous flow heater or heat exchanger which allows the heat present at the site of the fire to be used to generate steam and pressure. The steam thus generated can then be used to extinguish the fire, as it has a greater extinguishing effect than liquid water.

The advantage of the continuous flow heater that is key for fighting fires consists inter glia in the fact that the steam can be passed to the source of the fire only under high pressure. It can in addition be used to atomize additionally supplied extinguishing water. The advantage over the compressed air used for atomization consists in the fact that the air's oxygen content of 21% does not lead to more intensive combustion reaction on/at the source of the fire.

In a particularly preferred embodiment, the continuous flow heater is configured as a resilient spiral at the tip of the extinguishing tip. On the one hand, the tip of the extinguishing arm can be brought into direct contact—so as almost to be touching—with the source of the fire, without damaging the extinguishing arm. Furthermore, this increases the conduction of heat from the source of the fire to the extinguishing water in the continuous flow heater and thus also the steam power thereof.

In a particular embodiment of the continuous flow heater, the water vapour which is produced is passed into a cavity which annularly surrounds the extinguishing arm element. The cavity is configured as an annular nozzle and has openings which are distributed over its circumference and via which the steam from the continuous flow heater is emitted directed toward the source of the fire. In this case, the annular nozzle is movably mounted on the extinguishing arm element. A further advantage of the movable mounting is that the nozzle accommodates the momentum of the water vapour.

In a further preferred embodiment, the continuous flow heater can consist of a plurality of pipes and/or the annular nozzle be arranged so as to be multiply distributed over the circumference of the extinguishing arm.

In a particularly preferred embodiment, the steam generated by the continuous flow heater drives a turbine at the extinguishing tip, with which the extinguishing water supplied to the extinguishing tip is atomised under high pressure. The effect is very similar to that of a turbopump. The advantage of this embodiment consists in the fact that the water need not be passed already at/under high pressure from the extinguishing agent/water reservoir through the feed line to the extinguishing tip, but rather is brought to the required pressure only at the end of its path. In addition, this requires the use of only the heat generated by the source of the fire, and further, externally supplied energy is required only when the pressure at the extinguishing tip has to be increased still further. Accordingly, solutions are also conceivable which consist of a combination of any desired compressors and the turbopump described hereinbefore.

In order to allow the extinguishing arm to be used with as little danger as possible, it is advantageous to design its support or its base so as to be as steady and stable as possible. For this purpose, use is conventionally made of protruding legs which increase the footprint/base area of the support. If such extending of the base area is not possible, it is advantageous to use counterweights with which the reach of the extinguishing arm can be significantly increased. These counterweights serve to keep the displacement of the centre of gravity of the arrangement as a whole as low as possible. Such counterweights are in a particularly preferred embodiment packed onto travelling bases, for example trucks. This additionally allows continuous displacement of the arrangement as a whole and thus more flexible use and more effective and more advantageous positioning of the extinguishing tip. It is conceivable to use, in addition to the vehicle transporting the extinguishing arm, a further vehicle which transports the counterweight to the extended extinguishing arm or acts as an entire unit as a counterweight. The two vehicles can be coupled via various supports and cable connections.

It is particularly advantageous to use a counterweight even when a firefighter has to handle a protruding support structure which carries the extinguishing tip and contains one or more extinguishing arms. As a result of the counterweight, an equilibrium of moments can be created and the centre of gravity of the arrangement can be kept as close as possible to the person's body.

The invention will be described hereinafter in greater detail based on exemplary embodiments and with reference to the drawings, in which:

FIG. 1 is a plan view of two segments of an extinguishing arm;

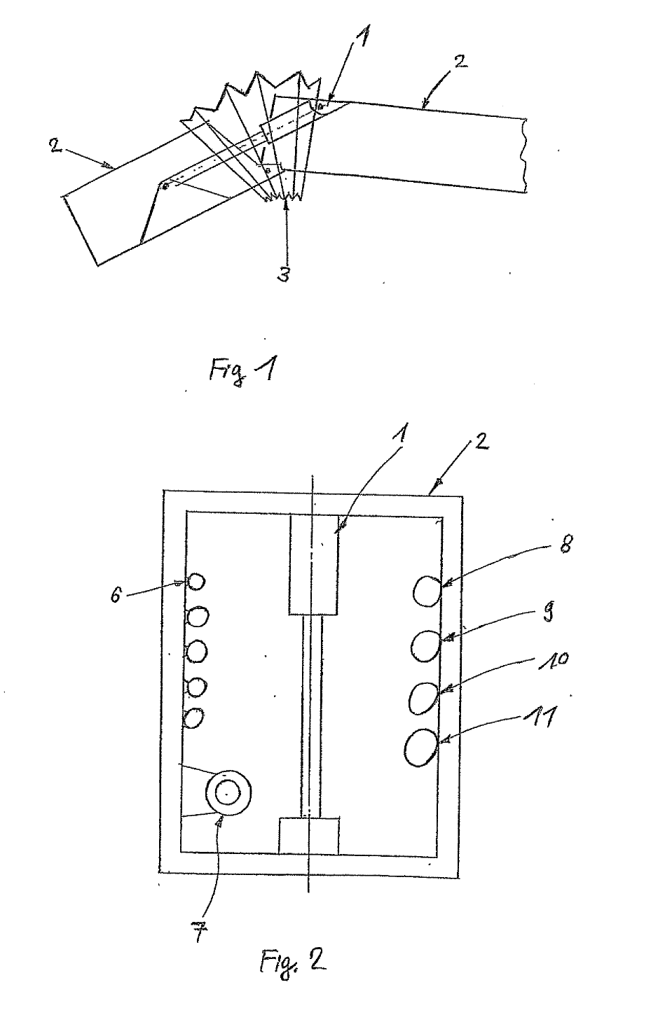

FIG. 2 is a cross section of a square tubular segment with built-in parts;

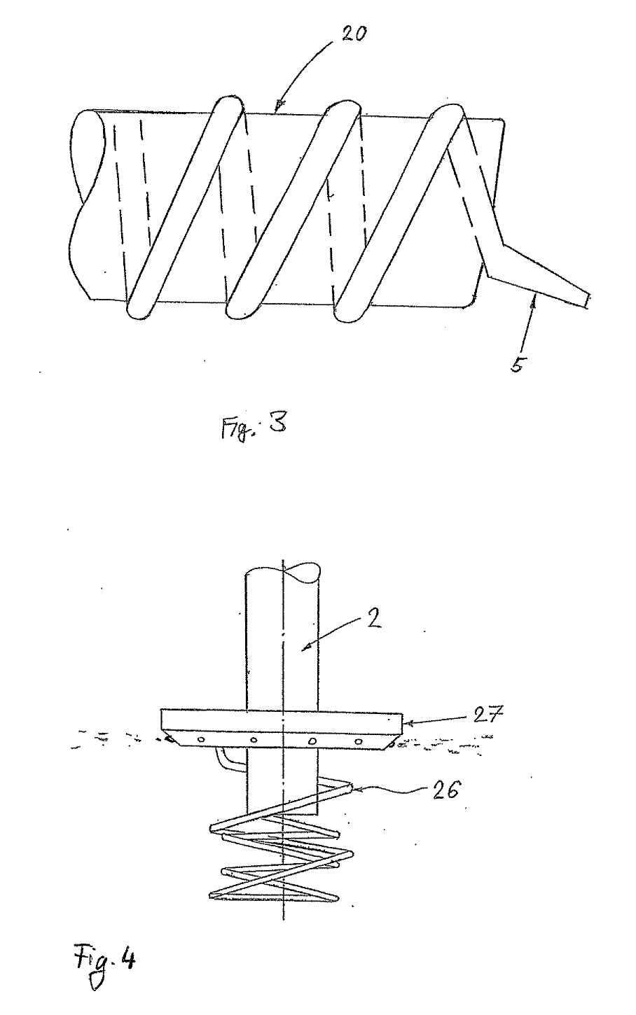

FIG. 3 is a side view of a continuous flow heater;

FIG. 4 is a side view of a double-helical (spiral)-shaped continuous flow heater with an annular nozzle;

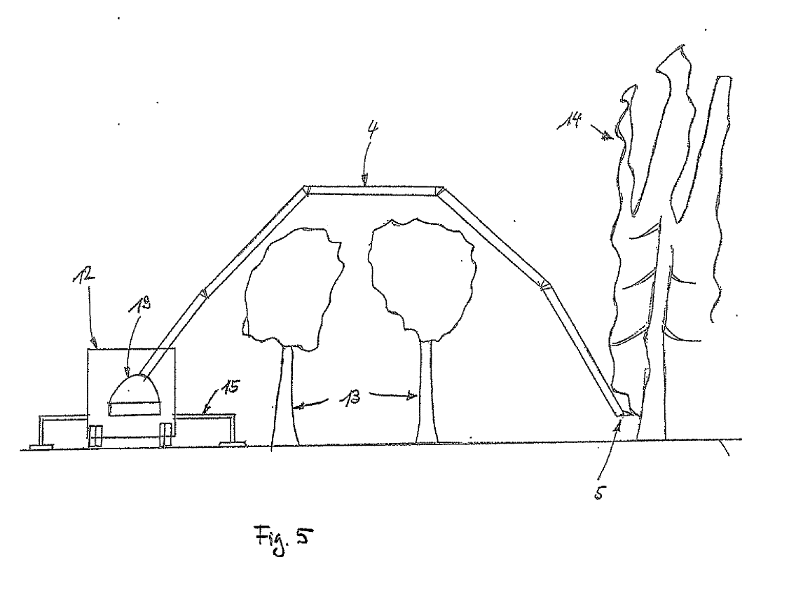

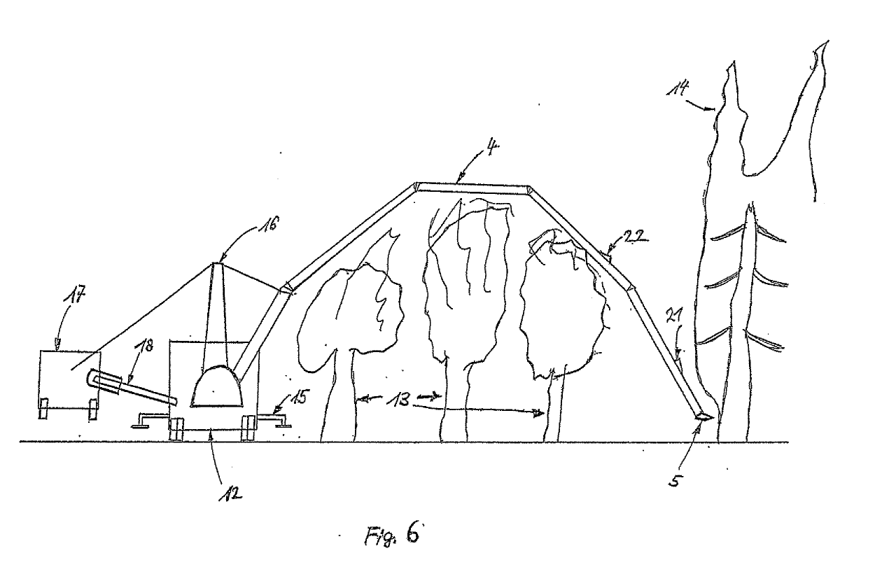

FIG. 5 is a perspective basic view of an exemplary embodiment with an extinguishing arm carrying truck;

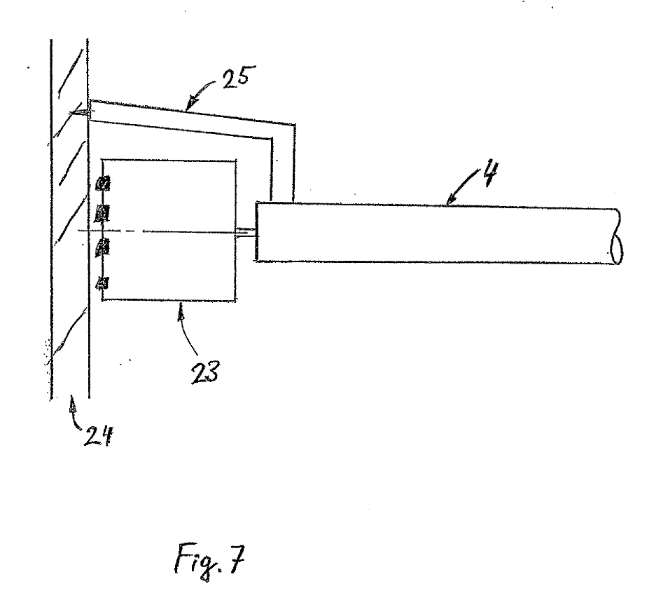

FIG. 6 shows an exemplary embodiment with an extinguishing arm carrying truck and a counterweight and/or a counterbalancing truck;

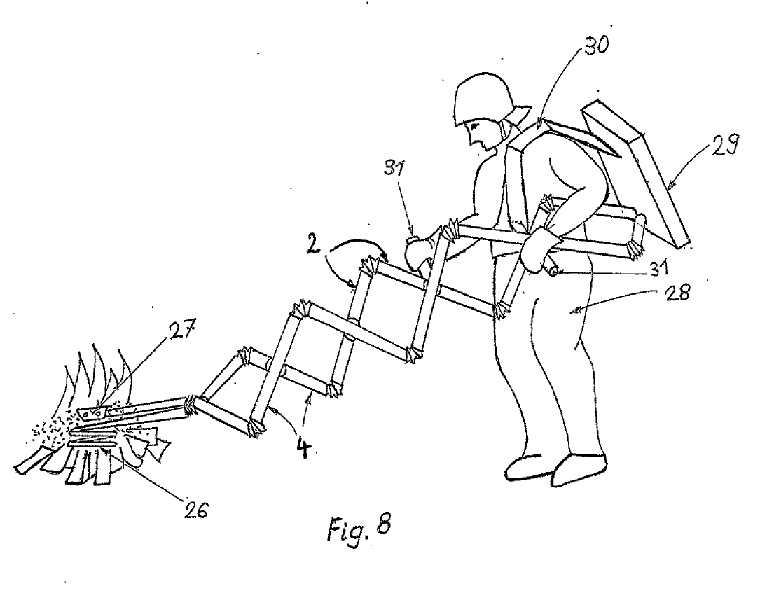

FIG. 7 is a plan view of an exemplary embodiment with a circular drill with a bolt-firing apparatus; and

FIG. 8 is a perspective view of an extinguishing device according to the invention which can be carried by a person.

FIG. 1 shows an extinguishing arm according to the invention which consists of a plurality of segments (2) which are embodied here as tubular elements having rectangular closed cross sections. The extinguishing agent, generally water, is passed through the segments (2). The elements are made preferably of steel, aluminum, fibre-reinforced concrete, plastics material or other suitable materials. The individual segments (2) are connected via flexible seals (3). The segments (2) are moved and articulated by hydraulic drives (1), cables, pneumatics, threaded rods, electric motors or another drive and form in this way a curved channel (cf. FIGS. 5 and 6).

Ball-and-socket joints can also be used. If no obstacles, such as foundation walls of a burning building, trees, bushes or other articles, impede free access, the extinguishing arm can also be oriented directly—horizontally—onto a source of a fire. This significantly increases the safety distance between the source of the fire and the operators.

FIG. 2 is a cross section of an embodiment of an extinguishing arm segment (2) with a rectangular hollow profile according to the invention. On the inside of the hollow profile (2), hydraulic (7), pressure (6, 8), foam-generating (8) extinguishing devices and also electric (11), optical (9) and electronic (10) feed lines or other connections are guided up to the tip of the extinguishing device. It is however conceivable to arrange feed lines and connections of this type also on the outside of the segment (2) or of the extinguishing arm (4), as usually not all segments (2) are exposed to equally high temperatures. For this reason, the individual segments can be made of different materials and assembled to form an extinguishing arm (4). Accordingly, the cross section, heat resistance and also size and weight can be taken into account in the dimensioning of the extinguishing arm (4).

In this particular embodiment, an additional water line (7) is provided with relatively cold water for cooling an IR camera, so that the camera, which is arranged at the extinguishing tip (5), still remains operative in direct proximity to the source of the fire. The IR camera, which is arranged close to the extinguishing tip (5), can be used to locate the source of the fire even through thick smoke. The extinguishing tip (5) is brought right up close to the source of the fire with the aid of hydraulic controllers. A normal video camera can also be installed. For applications in an inside attack, a plurality of cameras are beneficial. A further cooling water hose (7) runs within the extinguishing arm (4). This cooling water hose (7) can be heat-insulated relative to the cooling water of the extinguishing arm. Although all of the built-in parts and also the extinguishing arm (4) itself are cooled by the extinguishing agent/extinguishing water conveyed in the hollow profile of the segment (2), in some cases it is necessary to use the water at a lower temperature, for example for cooling sensors and the cameras.

FIG. 3 shows a continuous flow heater (20) which uses the heat from a source of a fire to generate water vapour such as is used in an extinguishing tip (5) according to the invention. Water vapour has a higher extinguishing effect than liquid water. The heat from the source of the fire heats the water which is present in the continuous flow heater (20) to above 100° C. and generates water vapour. This water vapour is then applied to the source of the fire. A nonreturn valve (not shown) ensures the direction of the steam pressure.

Additionally, relatively cool water or foam can also be added. The foam-generating chemical additive is for this purpose conventionally supplied via a separate hose.

FIG. 4 is a side view of a double-helical (spiral-)shaped continuous flow heater (26) with an annular nozzle (27). The continuous flow heater (26) is formed here as a resilient spiral. The advantage of the resilient spiral (26) consists in the fact that a source of a fire can be felt out, and in addition maximum heat, which serves to generate the steam in the continuous flow heater (26), can be accommodated via the spiral(s). In the illustrated embodiment, the water vapour which is produced is passed into a cavity which annularly surrounds the extinguishing arm segment (2). This ring (27) has openings which are distributed over the circumference and via which it emits the steam directed toward the source of the fire. The annular nozzle (27) is able to accommodate or to damp the momentum of the water vapour.

If the temperature on the continuous flow heater (26) is not sufficient to evaporate the water, compressed air which is supplied can be used to atomize the extinguishing water, which is conveyed in the extinguishing arm (4), at the extinguishing tip (5). In the case of very high temperatures at the source of the fire, too much steam can be generated under high pressure. The arrangement then resembles a rocket engine which causes a powerful recoil at the extinguishing tip. For this reason, the direction of the steam from individual, or in exceptional cases all of the, holes in the annular nozzle (27) can be oriented perpendicularly to the centre axis of the extinguishing element. The momentum of the steam flowing out radially in a plane is then distributed uniformly in all spatial directions and as a result does not lead to a recoil which could destabilise the extinguishing arm (4) or could cause it to vibrate. This additionally allows the design of an extinguishing arm (4) which can be carried and steered by firefighters.

In a further variant (not shown) of the described embodiment, the annular nozzle (27) can also be arranged below the continuous flow heater (26) and assume a pointed shape, as a result of which it is suitable for extinguishing, for example, pockets of embers from the bottom up.

FIG. 5 is a perspective basic view of an exemplary embodiment of the invention with an extinguishing arm carrying truck (12). The extinguishing arm carrying truck (12) takes all the equipment for controlling the extinguishing arm (4) and the extinguishing tip (5). The extinguishing arm (4) is in this case guided through obstacles, for example trees (13), with its extinguishing tip (5) to the source of the forest fire (14). The extinguishing arm (4) is movably mounted at its further end—that opposing the extinguishing tip (5)—on a mast block (19). For stabilising the extinguishing arm carrying truck (12), lateral legs (15) are extended, which thus increase the base area or footprint of the extinguishing device according to the invention and offer better support to the extinguishing arm carrying truck (12). The extinguishing arm carrying truck (12) can additionally carry further equipment required for fighting fires, which equipment increases its overall weight. Higher weight leads to a stabler position of the extinguishing arm carrying truck (12). For example, a compressor for pressures of up to 250 bar is built into the extinguishing arm carrying truck (12). The compressed air is conveyed via a flexible high-pressure hose, which is received in the extinguishing arm (4), to the front of the extinguishing tip (5). Optionally, nitrogen from pressure cylinders or any other gas suitable for extinguishing can also be passed through this hose. The heated cooling and extinguishing water is blown from right next to the source of the fire (14) by the extinguishing tip (5) under high pressure with compressed air and atomised finely onto the source of the fire (14).

FIG. 6 shows an exemplary embodiment with an extinguishing arm carrying truck (12) and a counterweight (17) and/or a counterbalancing truck (17). A counterweight (17) can be used to relieve the pressure on the legs (15) on the extinguishing arm carrying truck (12). This weight can be carried on the extinguishing arm carrying truck (12). In a further embodiment, another counterbalancing truck (17) can be this counterweight and be engaged with the extinguishing arm using movable gripping arms. The spacing can be adjusted in such a way that the overall centre of gravity of the extinguishing arm (4) and counterbalancing truck (17) again lies above the extinguishing arm carrying truck (12). The lateral legs (15) of the extinguishing arm carrying truck (12) are now relieved of pressure. A further advantage consists in the fact that the entire arrangement can now travel again. The wheels of the counterbalancing truck (17) form in this case an additional safety support. The extinguishing arm (4) can be guided along a fire front (15), such as for example that of a forest fire.

At/on difficult terrain, the counterbalancing truck (17) can again be lowered to the ground and the extinguishing arm (4) oriented in such a way that its centre of gravity lies between both trucks. The drive of the compensating truck then assists the propulsion of the arrangement. A mast (16) in the centre of the extinguishing arm carrying truck (12) can be constructed to relieve the pressure on a hydraulic system. This increases safety and extends the maximum length of extension of the extinguishing arm (4). In this embodiment, the IR camera (21) and also the video camera (22) were attached to/on different segments (2) of the extinguishing arm (4). It is conceivable to arrange the two cameras also in/at the extinguishing tip (5).

FIG. 7 is a plan view of an exemplary embodiment of a tool arranged on the extinguishing arm (4) or a segment (2), a circular drill (23) with a bolt-firing apparatus (25). A circular drill can be mounted at the front or instead of the extinguishing tip (5) on the extinguishing arm (4). The circular drill (23) can be driven by means of compressed air or another energy source. It can be used to penetrate walls (24), and thus to provide direct access to a source of a fire. Before drilling, the circular drill (23) can for example be secured by a bolt-firing head (25) to the wall (24) in order in this way to damp possible oscillations of the extinguishing arm (4). Likewise, it is conceivable to attach further different tools to the extinguishing arm (4).

The perspective view illustrated in FIG. 8 of an extinguishing device according to the invention which can be carried by a person is to be read in conjunction with FIG. 4. An annular nozzle (27) and a continuous flow heater (26) are supplied with water via cross-articulated extinguishing arms (4) as a movable extinguishing arm segment (2). This principle is also used with lifting platforms. The annular nozzle (27) can also be attached below a heat exchanger or a continuous flow heater (26). The person can carry a water tank (29) on his back. A suitable design, for example with cross joints, allows the water tank to move rearwards while the extinguishing arm is extended. The common centre of gravity of the extinguishing arm and water tank changes only slightly and the extinguishing device can comfortably be carried by a firefighter (28) via a shoulder strap (30). The extinguishing arms (4) can be brought together via two handles (31), and the extinguishing device according to the invention is so compact that it can be transported through hallways, door frames and corridors. This extinguishing device can be used to fight a source of a fire from a distance from 5 to 10 metres. The extinguishing arm(s)(4) can be curved via the handles. The firefighter (28) can thus extinguish from a cover, and does not need to expose himself to the direct heat radiation from the source of the fire. In addition, a pressure wave of an explosion behind a cover does not have such grave consequences.

Furthermore, an extinguishing apparatus of this type is also light to carry around, for example on a motorcycle. The high effectiveness of the extinguishing method makes a 10-litre tank 20 to 50 times as effective as in the past. A warning signal can for example enable a motorcycle to pass more easily through large towns in the event of high traffic density or traffic jams. In the case of a forest fire (14), individual pockets of embers are often still present after an extensive extinguishing process carried out from an aeroplane or helicopter. These pockets can be tracked down and extinguished using a motorcycle. Small fires, which have formed from sparks flying from a larger fire, can quickly be approached and extinguished in a targeted manner. Thus, for example, a fire break in a forest can be made safe.

An extinguishing arm guide of this type is possible also on a vehicle such as the foregoing aforementioned trucks.

### LIST OF REFERENCE NUMERALS

1 Actuator
2 Movable extinguishing arm element
3 Flexible seal
4 Extinguishing arm
5 Extinguishing tip
6 Hydraulic feed lines to the actuators
7 Cold water supply to the IR camera
8 Compressed air
9 Image info video camera
10 Image info IR camera
11 Supply of power to cameras
12 Extinguishing arm carrying truck
13 Forest with or without fire
14 Forest fire
15 Lateral legs
16 Mast
17 Counterbalancing truck
18 Spacing adaptation
19 Mast block, rotatable
20 Continuous flow heater for extinguishing water
21 IR camera
22 Video camera
23 Circular drill with bolt-firing apparatus
24 Wall of a burning building
25 Bolt-firing apparatus
26 Spiral-shaped continuous flow heater
27 Annular nozzle
28 Firefighter
29 Water tank
30 Shoulder strap
31 Handle

1-21. (canceled)

22. A device for extinguishing a fire and distributing extinguishing agents thereto comprising:
at least one movable extinguishing arm through which the extinguishing agents are passed; and
an extinguishing tip fastened to an outside of one end of the extinguishing arm and a transport or fastening unit fastened to another end of the extinguishing arm, wherein the extinguishing arm includes in a longitudinal direction thereof a plurality of segments articulated to one another, wherein the number and length of the segments are selected such to permit the extinguishing tip to be positioned in direct proximity to a source of the fire when used to fight the fire.

23. The device according to claim 22, wherein each of the segments are movable and rotatable relative to one another by means of at least one actuator.

24. The device according to claim 23, wherein at least one of the segments of the extinguishing arm is a telescopic arm.

25. The device according to claim 22, wherein each of the segments are hollow.

26. The device according to claim 22, wherein each of the segments are connected to one another via flexible seals.

27. The device according to claim 22, wherein the extinguishing arm is constructed of heat-resistant material.

28. The device according to claim 22, wherein each of the segments includes feed lines arranged internal or external to respective cross-sections of each of the segments.

29. The device according to claim 28, wherein the feed lines include hydraulic lines, pneumatic lines, at least one power line, at least one communication or control line, at least one extinguishing agent line, and a coolant line.

30. The device according to claim 22, wherein the number of segments of the extinguishing arm is modular for modular expansion thereof with additional segments.

31. The device according to claim 22, wherein the extinguishing tip is fastened to the extinguishing arm to be able to move and rotate independently of movement of the extinguishing arm.

32. The device according to claim 22, wherein the extinguishing tip includes a video camera or an infrared camera.

33. The device according to claim 22, wherein the outside of the one end of the extinguishing arm is adapted to receive a circular drill or a bolt-firing apparatus.

34. The device according to claim 22, wherein the extinguishing tip includes a continuous flow heater having at least one pipe for receiving an extinguishing agent or extinguishing water therethrough.

35. The device according to claim 34, wherein the continuous flow heater is formed as a resilient spiral.

36. The device according to claim 34, wherein the extinguishing tip or extinguishing arm includes at least one fixed or movable nozzle.

37. The device according to claim 36, wherein the nozzle is an annular nozzle.

38. The device according to claim 37, wherein the nozzle is connected to the continuous flow heater or a compressed air supply.

39. The device according to claim 37, wherein the extinguishing tip includes a turbine driven by steam generated by the continuous flow heater.

40. The device according to claim 22, wherein the device is attached to an extinguishing vehicle or operated by a person.

41. The device according to claim 40, further comprising:
a counterweight situated on the extinguishing arm of the extinguishing vehicle to counterbalance the weight of the extinguishing arm; or
a counterweight counterbalancing vehicle associated with the extinguishing vehicle, wherein the counterweight counterbalancing vehicle adjoins the extinguishing arm to carry cables passed and supported through the extinguishing vehicle.

42. The device according to claim 41, wherein the counterweight is a tank containing the extinguishing agent.
